(19) United States
(12) Patent Application Publication
(10) Pub. No.: US 2008/0245904 A1
(43) Pub. Date: Oct. 9, 2008

(54) Valve Arrangement

(76) Inventors: Anthony Harcombe, Surrey (GB); Mark Graham, West Sussex (GB)

Correspondence Address: DELPHI TECHNOLOGIES, INC., M/C 480-410-202, PO BOX 5052, TROY, MI, 48007, US

(21) Appl. No.: 11/885,826

(22) PCT Filed: Mar. 3, 2006
(86) PCT No.: PCT/GB2006/000760

§ 371 Date: Sep. 5, 2007

(30) Foreign Application Priority Data
Mar. 9, 2005 (EP) 05251432.0

(51) Int. Cl. B05B 1/30

(52) U.S. Cl. 239/569; 123/446

(57) ABSTRACT

A shut off valve arrangement for use in a fuel injection system includes a shut off valve member operable between a closed position in which the shut off valve member is engaged with a shut off valve seating and an open position in which the shut off valve member is disengaged from the shut off valve seating to control the supply of fuel to the injector through a fuel supply passage. The shut off valve member includes a first surface that is exposed to fuel pressure within a shut off valve control chamber, a second surface exposed to fuel within the fuel supply passage and a third surface exposed to fuel pressure in a balance chamber, wherein the shut off valve arrangement is provided with a control valve for controlling the pressure of fuel within the shut off control chamber, thereby to control movement of the shut off valve member between the open and closed positions. The shut off valve arrangement is further provided with communication means between the fuel supply passage and the balance chamber so that a balancing force acting on the third surface due to fuel pressure in the balance chamber opposes an opening force acting on the second surface.

### TECHNICAL FIELD

The present invention relates to a valve arrangement and, in particular, to a valve arrangement for use in a fuel system for supplying fuel to an internal combustion engine.

### BACKGROUND TO THE INVENTION

Our co-pending European patent application EP1359316 describes a fuel injection system which combines common-rail functionality with that of Electronic Unit Injector (EUI) systems. Fuel systems utilising a combination of these technologies are commonly referred to as “hybrid” fuel injection systems.

A hybrid common rail-EUI system includes a high pressure fuel pump which is arranged to charge a fuel volume (common rail) with fuel at high pressure, with the common rail being arranged to supply fuel to all of the injectors of the engine. Further, each injector includes a dedicated pump which forms a part of an EUI. Each dedicated pump includes a cam-driven plunger for raising fuel pressure within a pump chamber to a pressure level which exceeds common rail pressure.

An injection nozzle of each injector, through which fuel is injected into an associated cylinder of the engine, is controlled by means of an electronically controlled valve arrangement, so as to control the timing of commencement and termination of fuel injection. Fuel may be injected from the nozzle either at rail pressure, or at a higher pressure level supplied by the pump chamber, in dependence upon the status of a rail control valve located between the common rail and the pump chamber.

In one embodiment of the system described in EP1359316, each injection nozzle is provided with a nozzle control valve arrangement to control the timing of commencement and termination of injection. A valve needle of the nozzle has a control chamber at its back end which may be brought into communication either with a supply of high pressure fuel or with a low pressure drain under the control of the nozzle control valve. Fuel pressure within the control chamber acts on the valve needle to urge the needle to close (i.e. the non-injecting state). In order to open the valve needle to commence injection, the nozzle control valve is operated so as to bring the control chamber into communication with the low pressure drain. Fuel pressure in the control chamber decreases, and high pressure fuel supplied to the nozzle applies a lifting force to the valve needle which overcomes the reduced force acting to close the needle and, hence, the valve needle opens to commence injection. In order to terminate injection, the nozzle control valve is actuated to bring the control chamber into communication with the high pressure supply, thus re-establishing high pressure in the control chamber to cause the valve needle to re-engage its seat.

It has been recognised that a potential disadvantage of the system described above is that, when it is desired to close the valve needle to terminate injection, the valve needle is urged to close against the high pressure fuel supplied to the nozzle. This can lead to an undesirable fuel spray characteristic, particularly as a large quantity of fuel may be injected at low needle lift. Another disadvantage of forced needle closure is the resultant pressure wave activity due to inertia of the fuel and the sudden closing of the valve needle at high pressure. In particular, forced valve needle closure can affect detrimentally the stability, and thus quality, of any post injections (i.e. injection events following a main injection of fuel).

In an alternative embodiment of the system in EP1359316, a high pressure shut off valve arrangement is provided to control the timing of commencement and termination of injection. A high pressure shut off valve is located in the high pressure supply line which provides a communication path between the pump chamber (i.e. at common rail pressure or at the higher pressure level) and each of the injection nozzles. The shut off valve is movable under the influence of an electronically controlled valve, with a lower end of the shut off valve being engageable with a seating to control the flow of fuel through the supply line. When the shut off valve is engaged with the seating, fuel is unable to flow between the pump chamber and the injection nozzle. Conversely, when the shut off valve is lifted from its seating, the flow of fuel to the injection nozzle is permitted. When fuel is supplied to the nozzle, the valve needle is caused to lift from its seating due to an upward lifting force acting on valve needle thrust surfaces. A spring is provided for the valve needle so that when the fuel supply to the nozzle is cut-off, the fuel pressure within the nozzle gradually decreases due to fuel being expelled from the nozzle and thus the spring urges the valve needle to close against its seating.

The control valve is operable to control whether a control chamber located at the upper end of the shut off valve is able to communicate either with a low pressure drain or with a supply of high pressure fuel. If the control valve is operated to allow high pressure fuel to flow into the control chamber, the shut off valve is urged against its seating and the flow of fuel to the nozzle is terminated. If the control valve is operated to allow the control chamber to drain to low pressure, which cuts off communication with the high pressure supply, the upward force acting on the high pressure shut off valve, due to fuel within the supply line, overcomes the closing force due to fuel pressure within the control chamber and, hence, the shut off valve opens. Additionally, as the shut off valve starts to open, the lowermost end face of the valve will also experience building pressure in the downstream portion of the supply line and so eventually the entire end surface of the shut off valve is exposed to high pressure fuel.

Whilst the provision of the high pressure shut off valve has been shown to eliminate the problems described above which are associated with nozzle control valves for injection control, other disadvantages may be encountered for certain applications. For example, it has been noticed that the high pressure shut off valve opens very rapidly, due to building pressure beneath the valve as the shut off valve starts to open. This places a restraint on the system when fast needle movement is required so that multiple injection strategies (for example multi-pilot or multi-main injections of fuel) are difficult to achieve. Multiple injection strategies are recognised as providing significant improvements in combustion quality and efficiency and are a desirable feature of current fuel injection systems if they are to meet increasingly stringent emissions regulations.

The problems described above in relation to hybrid common rail-EUI systems are also evident in conventional EUI systems, in which there is no common rail functionality but a dedicated pumping element provides pressurised fuel to an associated one of the injectors, and also in common rail type systems with no EUI component. Conventional EUI systems also are limited by the fact that it is only possible to inject fuel through a particular injector during the pumping stroke of its associated pump unit.

It is one aim of the present invention to provide a valve arrangement, suitable for use in common rail, EUI or hybrid systems, in which the aforementioned disadvantages of known valve arrangements are removed or alleviated.

### SUMMARY OF THE INVENTION

Against this background, according to a first aspect of the present invention, there is provided a shut off valve arrangement for use in a fuel injection system including an injector, the shut off valve arrangement including a shut off valve member operable between a closed position in which the shut off valve member is engaged with a shut off valve seating and an open position in which the shut off valve member is disengaged from the shut off valve seating to control the supply of fuel to the injector through a fuel supply passage. The shut off valve member has, associated therewith, a first surface that is exposed to fuel pressure within a shut off valve control chamber, a second surface exposed to fuel within the fuel supply passage and a third surface exposed to fuel pressure in a balance chamber, the shut off valve arrangement further including a control valve for controlling the pressure of fuel within the shut off control chamber, thereby to control movement of the shut off valve member between the open and closed positions. The shut off valve arrangement is provided with communication means between the fuel supply passage and the balance chamber so that a balancing force acting on the third surface due to fuel pressure in the balance chamber opposes an opening force acting on the second surface.

The shut off valve member may be formed from a unitary part, in which case the first, second and third surfaces are all defined by a common part, or alternative may be formed from two or more parts, in which case the surfaces may be defined by separate parts of the shut off valve member.

Preferably, the first surface is defined by a first end region of the shut off valve member, the second surface is defined by a second end region of the shut off valve member and the third surface is defined by an intermediate region of the shut off valve member.

Since fuel pressure within the balance chamber acting on the shut off valve member opposes the force urging the shut off valve member to disengage the shut off valve seating, a relatively low net upwards force acts on the shut off valve member during its opening movement. As a consequence, the shut off valve member is more responsive to a rise of pressure within the control chamber and, therefore, it is possible to close the shut off valve member more rapidly than if the balance chamber were omitted. By virtue of the increased responsiveness of the shut off valve member to changes of fuel pressure within the control chamber, greater injection flexibility is realised. For example, it is possible to open and close the control valve rapidly which causes the shut off control valve member to “flutter” or “hover” between its open and closed positions. As a result, a pulsed fuel delivery is achieved which is advantageous in reducing exhaust emissions and engine noise. In addition, the effects of wear of the shut off valve member are reduced since the impact forces acting on the shut off valve member are less severe.

In order to provide further control of the movement of the shut off valve member, the shut off valve arrangement may include drain means for allowing fuel within the balance chamber to flow to a low pressure drain. By arranging the drain means such that it is only effective over a part of the range of movement of the shut off valve member, it is possible to control accurately the rate of decay of fuel pressure within the fuel supply passage. The drain means may also include a restriction for restricting the rate of flow of fuel from the balance chamber to the low pressure drain.

Although the restriction may be defined by a narrow drilling within a valve housing piece, alternatively the restriction may be defined by a replaceable restriction member located within a drain passage provided in a shut off valve housing of the shut off valve arrangement. The restriction member may be provided with a through drilling to provide the restriction or, alternatively, the restriction member may define an annular restriction.

In an alternative embodiment of the invention, the shut off valve arrangement further comprises a spring which serves to urge the shut off valve member towards the shut off valve seating. The spring is most suitable in circumstances in which the shut off valve member is manufactured as a single part and requires an additional biasing force to urge into engagement with the shut off valve seating.

In another alternative embodiment, the shut off valve member includes a first part slidable within a first bore provided in a shut off valve housing and a second part slidable within a second bore provided in a separate housing part, wherein the separate housing part is movable with the shut off valve member. The first and second bores are therefore arranged to face one another so as to receive a respective portion of the shut off valve member.

In another aspect of the present invention, there is provided a shut off valve arrangement for use in a fuel injection system including an injector, the shut off valve arrangement including a shut off valve member operable between a closed position in which the shut off valve member is engaged with a shut off valve seating and an open position in which the shut off valve member is disengaged from the shut off valve seating to control the supply of fuel to the injector through a fuel supply passage. The shut off valve arrangement further includes a control valve for controlling the pressure of fuel within the shut off control chamber, thereby to control movement of the shut off valve member between the open and closed positions and drain means for allowing fuel within the fuel supply passage to flow to a low pressure drain.

Although the drain means may be arranged such that fuel within the fuel supply passage is only prevented from flowing to the low pressure drain when the shut off valve member is in its open position, the drain means may also be arranged to be effective over a part of the range of movement of the shut off valve member.

The drain means may also include a flow restriction means for restricting the rate of flow of fuel from the fuel supply passage to the low pressure drain.

In another aspect, the invention relates to a fuel injection system including high pressure fuel supply means for supplying high pressure fuel to a fuel injector arrangement via a fuel supply passage and a shut off valve arrangement as described above for controlling the flow of fuel to the fuel injector arrangement through the fuel supply passage.

### BRIEF DESCRIPTION OF THE DRAWINGS

In order for the invention to be more readily understood, embodiments thereof will now be described, by way of example only, with reference to the accompanying drawings in which:

FIG. 1 shows a schematic view of a fuel injection system in which the present invention may be incorporated;

FIG. 2 shows a sectional view of a shut off valve arrangement in accordance with a first embodiment of the invention;

FIGS. 3A to 3E show sectional views of the shut off valve arrangement of FIG. 2 in successive stages of operation;

FIGS. 4 and 5 show sectional views of flow restriction components for use with the shut off valve arrangement in FIGS. 2 and 3A to 3E;

FIG. 6 shows a sectional views of a shut off valve arrangement of a second embodiment;

FIG. 7 shows a sectional view of a shut off valve arrangement of a third embodiment;

FIGS. 8A to 8D show sectional views of a fourth embodiment of the shut off valve arrangement in successive stages of operation;

FIG. 9 shows an enlarged sectional view of a balance component for use with the shut off valve arrangement in FIGS. 8A to 8D; and

FIGS. 10 to 12 show sectional views of further embodiments of the shut off valve arrangement.

### DETAILED DESCRIPTION OF THE PREFERRED EMBODIMENTS

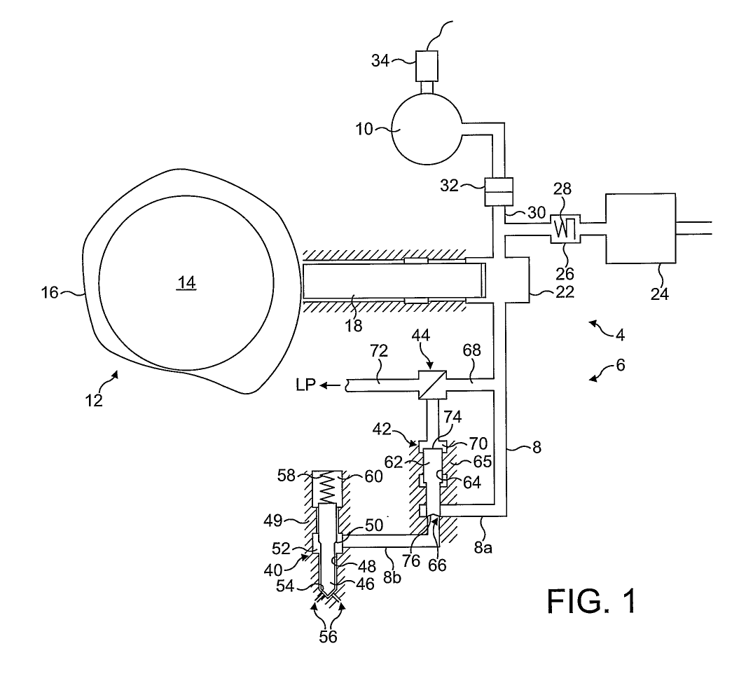

By way of background to the present invention, a known hybrid fuel injection system, referred to generally as 2, is shown in FIG. 1. The fuel injection system 2 includes a pump arrangement 4 which conveys pressurised fuel to a fuel injector arrangement 6 by way of a high pressure fuel supply passage 8. For clarity, only one pump arrangement 4 and one fuel injector arrangement 6 are shown in FIG. 1 although, in practice, a plurality of pump arrangements 4 with associated injector arrangements 6 would be provided to inject fuel into a plurality of associated engine cylinders (not shown). Conveniently, the pump arrangement 4 and its associated injector arrangement 6 may be arranged within a common unit, in a so-called unit injector.

The pump arrangement 4 is used to charge a common rail 10 to a first, injectable pressure level and includes a cam drive arrangement 12 having a driven cam 14, a surface 16 of which is operable to reciprocate a pumping plunger 18 within a plunger bore 20. An end of the pumping plunger 18 distal from the driven cam 14 serves to pressurise fuel contained within a pumping chamber 22. It should be mentioned at this point that the skilled reader would understand that the term “common rail” is not limited to an accumulator volume of any particular size, shape or structure and may, for example, be of linear or annular form, or any other configuration suitable for storing high pressure fuel.

Typically, the cams of each pump arrangement are mounted upon a common shaft that is driven by the engine drive shaft. As the pumping plunger 18 is driven, in use, it performs a pumping stroke in which it is moved to reduce the volume of the pumping chamber 22 and a return stroke in which the plunger 18 is moved to increase the volume of the pumping chamber 22. Typically, the pumping plunger 18 is provided with a plunger return spring (not shown) to effect the plunger return stroke.

A low pressure transfer pump 24 provides a source of low pressure fuel for filling the pumping chamber 22 prior to the pumping stroke of the pumping plunger 18. Communication between the pumping chamber 22 and an outlet of the transfer pump 24 is controlled by a non return valve 26 having a non return spring 28, the non-return valve 26 being hydraulically operable in dependence upon the difference in fuel pressure across it. During the return stroke of the pumping plunger 18, when fuel pressure in the pumping chamber 22 is decreasing, the pressure of fuel supplied by the transfer pump 24 is sufficient to overcome the force of the non-return spring 28 such that the non-return valve 26 is opened and fuel is supplied from the transfer pump 24 to the pumping chamber 22. Conversely, as the pumping plunger 18 is driven on its pumping stroke, the pressure of fuel within the pumping chamber 22 will be increased and the non-return valve 26 closes to prevent fuel being fed back to the transfer pump 24. As a consequence, continued movement of the pumping plunger 18 causes the pressure of fuel within the pumping chamber 22 to increase further.

Pressurised fuel within the pumping chamber 22 is supplied to the common rail 10 via a common rail supply passage or rail pressure line 30 under the control of an electrically operable valve arrangement in the form of a rail control valve 32. The rail control valve 32 is actuated to move between its open and closed positions in response to an electronic control signal provided by an associated engine control unit (not shown). The rail control valve 32 performs two functions: firstly, it permits the pressure and the volume of fuel supplied to the common rail 10 to be controlled and, secondly, the position of the rail control valve 32 determines whether fuel is injected at a first, moderate pressure (rail pressure) or at a second, higher pressure. If the rail control valve 32 is in an open state, the pressure of fuel within the pumping chamber 22 is pressurised to the first, moderate pressure and fuel at this pressure is supplied both to the fuel supply passage 8 and the rail supply passage 30. However, if the rail control valve 32 is in its closed state, fuel at the first pressure is retained within the pumping chamber 22 and is pressurised to the high pressure level when the pumping plunger 18 performs its pumping stroke.

The common rail 10 is provided with a rail pressure sensor 34 for monitoring the pressure of fuel within the common rail 10 and for providing an output signal indicative of the pressure of fuel within the rail. A pressure relief valve is provided (not shown), operable in response to the signal generated by the rail pressure sensor, to maintain the pressure within the common rail 10 at a desired pressure. The pressure of fuel within the common rail 10 may also be controlled by actuating the rail control valve 32 such that pressurised fuel from the common rail 10 is supplied to the pumping chamber 22 when the pumping plunger 20 moves through its return stroke.

Pressurised fuel is supplied to the injector arrangement 6 at either the first or the second pressure level, via the fuel supply passage 8. The injector arrangement 6 includes a fuel injector 40 having an injection nozzle, a shut off valve arrangement 42 and a control valve means in the form of a shut off control valve 44. The fuel injector 40 comprises a valve needle 46 which is slidable within a bore 48 formed in a nozzle body 49 to control fuel delivery through a set of nozzle outlets 56. The valve needle 46 includes angled thrust surfaces 50 orientated such that the application of fuel under high pressure from the fuel supply passage 8 to an injector delivery chamber 52 applies a force to the valve needle 46 urging it out of engagement with a valve needle seating 54 to permit fuel injection into the engine through the outlets 56. The fuel injector 40 also includes a biasing spring 58, housed within a spring chamber 60, which serves to urge the valve needle 46 against the valve needle seating 54.

The shut off valve arrangement 42 includes a shut off valve member 62 that controls communication between the fuel injector 40 and the pumping chamber 22 via the fuel supply passage 8. The shut off valve member 62 is moveable within a stepped bore 64 formed in a valve housing 65 and engages a shut off valve seating 66 defined at the lower end of the bore 64 to interrupt the flow of fuel through the fuel supply passage 8. Thus, the shut off valve member 62 serves to divide the supply passage 8 into an upstream portion 8a and a downstream portion 8b. The shut off valve member 62 is shown in a “closed” position in FIG. 1 and is moveable away from the shut off valve seating 66 into a second position (an “open” position) in which the flow of fuel through the fuel supply passage 8 to the injector delivery chamber 52 is permitted.

The control valve 44 is actuable to control the position of the shut off valve member 62, as will be described below, and is operable between a first (closed) position and a second (open) position. In the closed position, a branch passage 68 from the upstream supply passage 8a communicates with a control chamber 70 at the back end of the shut off valve member 62 and communication between the control chamber 70 and a low pressure drain is closed. In the open position, the control chamber 70 communicates with the low pressure drain through a drain passage 72 and communication between the control chamber 70 and the high pressure fuel supply passage 8 is broken. Although the control valve 44 is shown as a three-way valve, it should be appreciated that alternative means could be provided to control the pressure within the control chamber 70, for example a two-way valve operable by electromagnetic or piezoelectric means.

The shut off valve member 62 includes a first surface 74 defining a first effective surface area that is exposed to fuel pressure within the control chamber 70, and a second surface 76 which defines a second effective surface area that is exposed to fuel pressure within the downstream fuel supply passage 8b when the shut off valve member 62 is seated. The first effective surface area is arranged to be larger than the second effective surface area to ensure that the shut off valve member 62 will close when the control chamber 70 is charged with pressurised fuel.

The operation of the shut off valve arrangement 42 will now be described. When the control valve 44 is in its closed position and fuel pressure within the control chamber 70 is high, the shut off valve member 62 will be urged against the shut off valve seating 66 due to fuel pressure acting against the first effective surface area of the surface 74. Thus, high pressure fuel will not be supplied to the injector delivery chamber 52 and so fuel pressure within the injector will remain at a level at which the force of the spring 58 is sufficient to seat the valve needle (hereafter “nozzle closing pressure”).

When the control valve 44 is actuated to its open position, fuel pressure within the control chamber 70 will reduce as fuel therein is permitted to flow to the low pressure drain passage 72. As a result, the force acting on the first surface 74 urging the shut off valve member 62 into engagement with the shut off valve seating 66 is reduced such that the force acting upwards is sufficient to move the shut off valve member 62 away from the shut off valve seating 66.

As the shut off valve member 62 starts to open, the second surface 76 moves away from the shut off valve seating 66 and will experience a rise in pressure due to pressurised fuel flowing through the downstream fuel supply passage 8b. Almost immediately, the entire second surface 76 of the shut off valve member 62 is exposed to high fuel pressure and is driven into its fully open position. When the shut off valve member 62 is in this open state, fuel at either the first or the second injectable pressure level is able to flow past the shut off valve seating 66 and into the injector delivery chamber 52. As the pressure of fuel delivered to the injector delivery chamber 52 (and therefore to the downstream parts of the injector) builds, an increased force is applied to the thrust surfaces 50 of the valve needle 46 such that the closing force of the spring 58 is overcome and, therefore, an fuel injection event is initiated.

If it is desired to terminate injection, the control valve 44 is moved into its closed position, such that high pressure fuel within the fuel supply passage 8 is able to flow through the branch passage 68 and into the control chamber 70 at the upper end of the shut off valve member 62. Since the first effective surface area 74 of the shut off valve member 62 is greater than the second effective surface area, the shut off valve member 62 will be urged against the shut off valve seating 66 into its closed position and, as a result, the flow of fuel through the fuel supply passage 8 to the injector delivery chamber 52 is interrupted. Due to the continued flow of fuel out of the nozzle outlets 56 fuel pressure within the injector delivery chamber 52 will decay and a point will be reached where the closing force provided by the spring 58 is greater than the force due to fuel pressure acting on the thrust surfaces 50. The valve needle 46 will therefore be urged towards the valve seating 54 to terminate injection. Typically, the pre-load of the spring 58 is selected so that the pressure of fuel in the fuel supply passage 8, whether supplied at the first or second pressure levels, will decay to approximately 200 bar before the valve needle 46 closes.

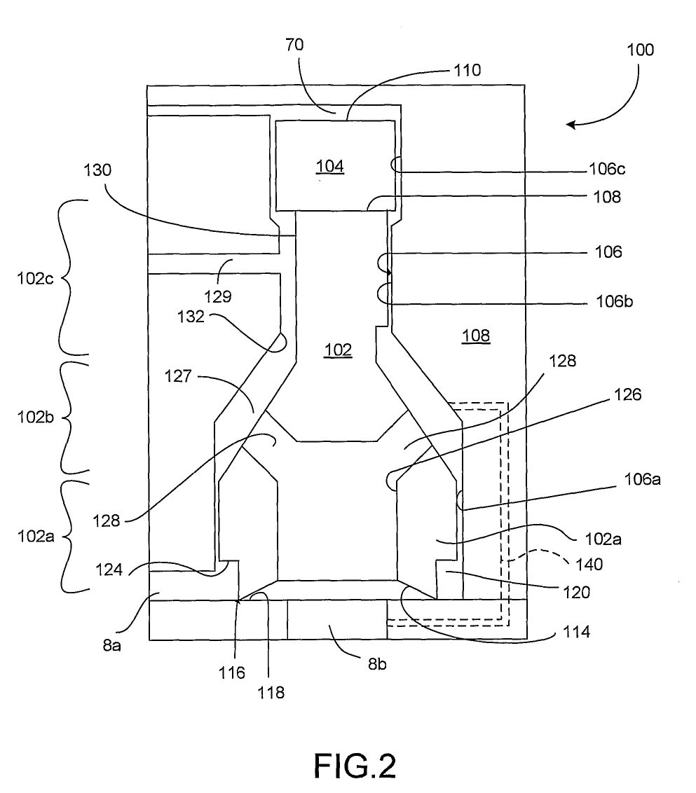

FIG. 2 shows an improved shut off valve arrangement, referred to generally as 100, that may be incorporated into the fuel injection system 2 described above. Where appropriate, like parts to those shown in FIG. 1 are denoted with like reference numerals.

Referring to FIG. 2, a shut off valve arrangement 100 comprises a shut off valve member 102 and a control piston 104, both of which are slidable within respective parts of a stepped plunger bore 106 provided in a valve housing 108.

The shut off valve member 102 includes a lower end region 102a of relatively large diameter which is slidable within an enlarged region 106a of the housing bore 106. The lower end region 102a tapers, or narrows, through a frustoconical region 102b into an upwardly projecting neck region 102c, which is slidable with a correspondingly narrow intermediate region 106b of the bore 106. The neck region 102c defines an upper end face 108 of the shut off valve member 106 which is engageable with the substantially cylindrical control piston 104. The control piston 104 itself is slidable within a further, upper region 106c of the bore 106 having a slightly larger diameter than the intermediate region 106b. An upper end surface 110 of the control piston 104 defines an effective surface area (referred to herein as the “first effective surface area”) which is exposed to pressurised fuel contained within the shut off control chamber 70 to provide a force on the shut off valve member 102 urging it downwards into the position illustrated in FIG. 2. The pressure of fuel within the shut off control chamber 70 is controlled in the same manner as described with reference to FIG. 1.

A lower end face 114 of the shut off valve member 102 is of frustoconical form and is exposed to fuel pressure within the downstream fuel supply passage 8b. An outer edge of the lower end face 114 defines an annular seating line 116 which is engageable with a substantially flat shut off valve seating 118 to control the flow of fuel from the upstream fuel supply passage 8a to the downstream fuel supply passage 8b. When the shut off valve member 102 is in the position shown in FIG. 2, the pressure of fuel in the downstream fuel supply passage 8b is relatively low and so a small force acts on the lower end face 114 of the shut off valve member 102.

The lower end region 102a of the shut off valve member 102 includes an annular recess 120 defining a volume which is in communication with the upstream fuel supply passage 8a. The annular recess 120 also defines a surface 124 that provides an effective surface area (herein referred to as the “second effective surface area”) upon which pressurised fuel acts in a direction to urge the shut off valve member 102 away from the shut off valve seating 118. When the shut off valve member 102 is seated, the force acting on the second surface 124 is insufficient to unseat the shut off valve member 102 since the second effective surface area is less than the first effective surface area defined by the control piston 104. The shut off valve member 102 therefore remains seated and the valve needle 46 is isolated from high pressure fuel.

The shut off valve member 102 is provided with a flow passage means in the form of an axial passage 126, a mouth of which opens at the lower end face 114 of the shut off valve member 102. The axial passage 126 extends upwardly within the shut off valve member 102 and splits into two branch passages 128, the mouths of which open at the surface of the frustoconical region 102b. The axial passage 126 and the branch passages 128 therefore provide a path for fuel to flow from the downstream fuel supply passage 8b to a chamber 127 defined between the bore 106 and the frustoconical region 102b of the shut off valve member 102, the purpose of which will be described below. Throughout the description, the chamber 127 will be referred to as the “balance chamber”.

A second shut off valve seating 132 is defined by the opening of the intermediate region 106c of the bore 106 and with which the frustoconical region 102b of the shut off valve member 102 is engageable. When the shut off valve member 102 is in its uppermost position it engages the second shut off valve seating 132 to ensure that pressurised fuel is prevented from flowing from the balance chamber 127 to a low pressure drain 129.

The neck region 102c of the shut off valve member 102 is provided with a flat or groove 130 which provides a channel through which fuel within the balance chamber 127 can flow to the low pressure drain passage 129 in circumstances in which the shut off valve member 102 is disengaged from the second seating 132. The flat 130 therefore allows fuel pressure within the downstream fuel supply passage 8b, and thus the injector delivery chamber 52, to vent to low pressure during termination of an injection which assists the closure of the valve needle 46 and improves fuel injection characteristics.

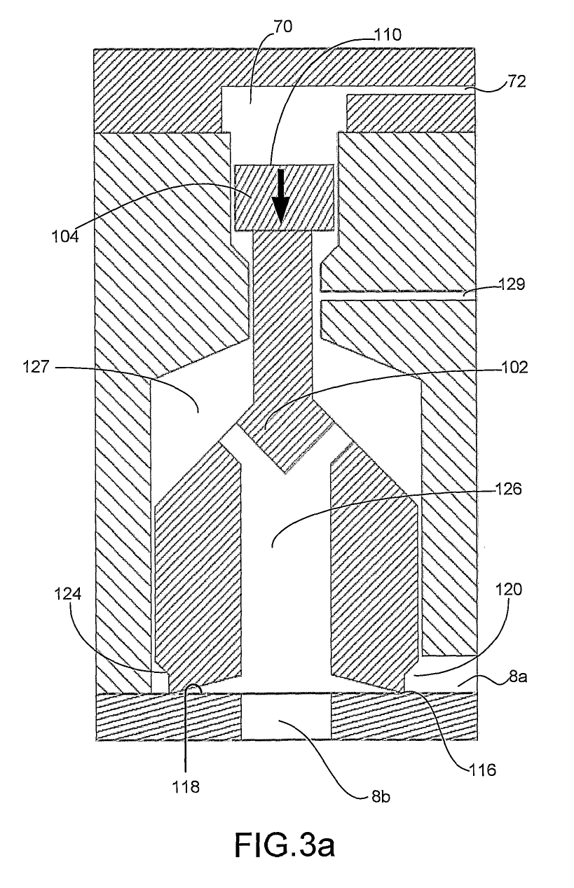

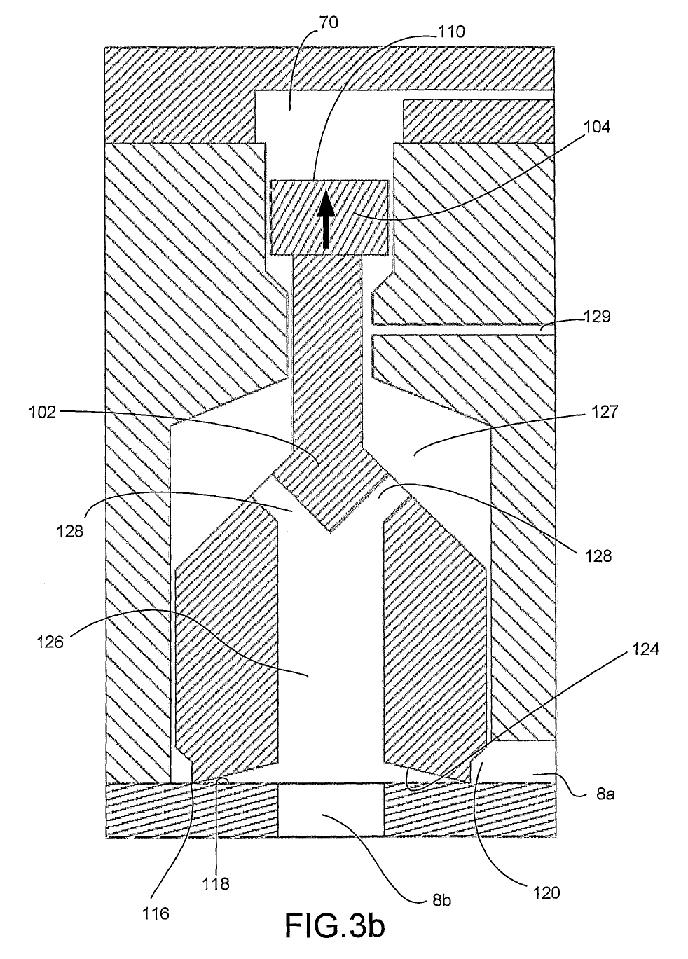

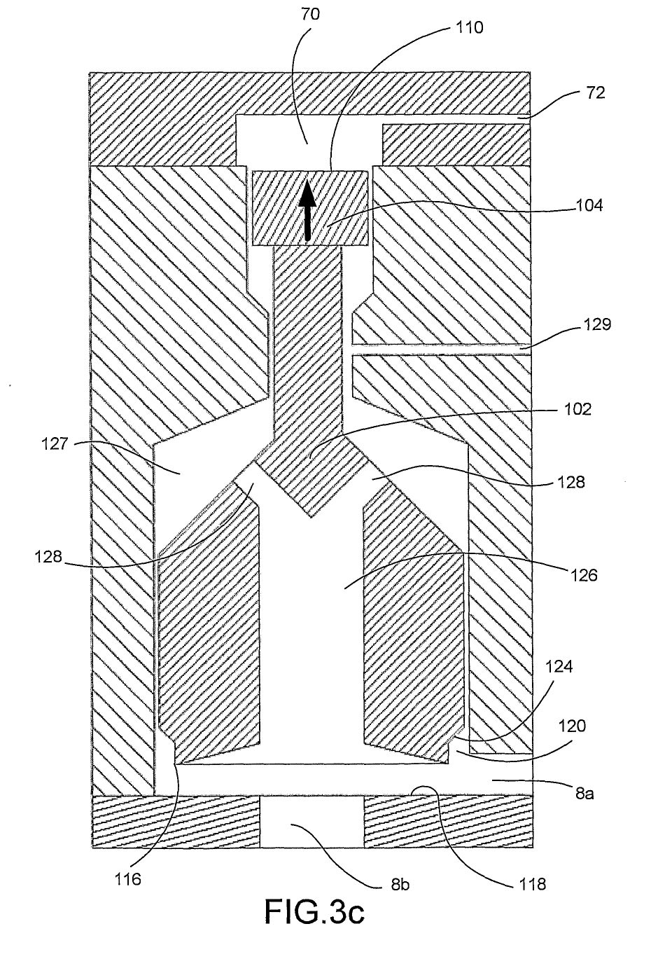

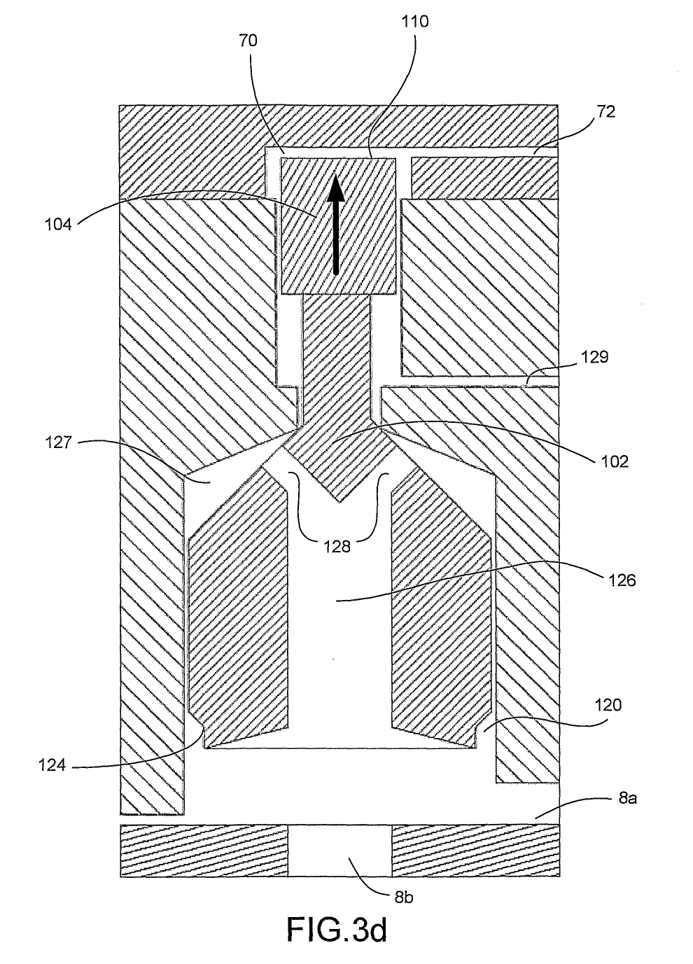

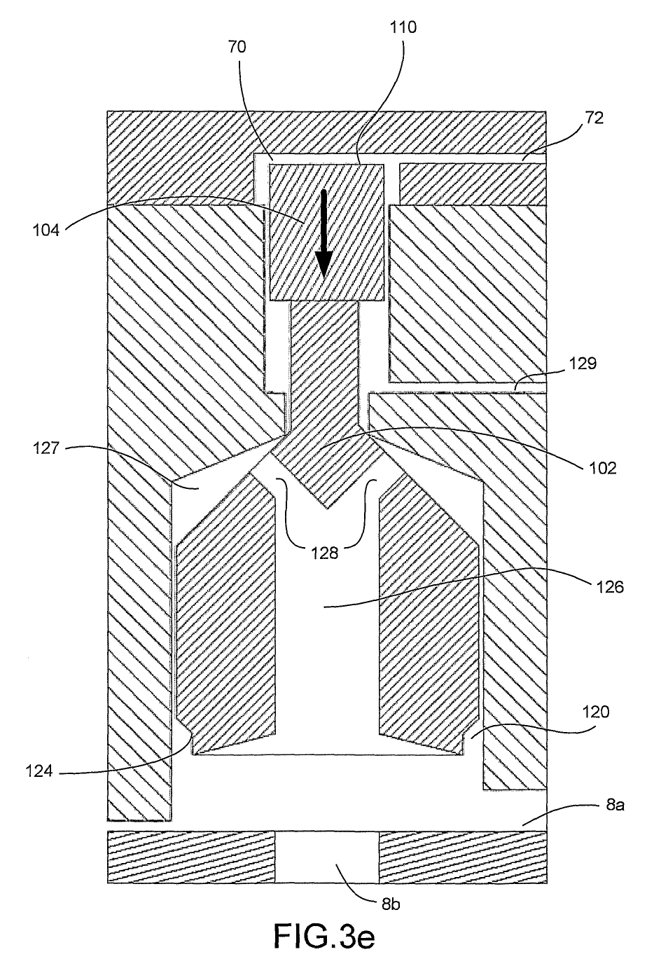

The operation of the shut off valve member 102 will now be described with reference to FIGS. 3A to 3E which show the shut off valve member 102 in successive states of operation. It will be appreciated that the dimensions of the shut off valve member 102 are slightly different in FIGS. 3A to 3E, compared with FIG. 2, in that the shut off valve member 102 has to travel further to seat against the seating 132 than in the former case. However, in all other respects the shut off valve arrangement is intended to be identical in FIGS. 2 and 3A to 3E.

In FIG. 3A, the shut off valve member 102 is in the same position as in FIG. 2. The control valve 44 is in the closed position such that the control chamber 70 is filled with high pressure fuel which acts on the upper end surface 110 of the control piston 104. Due to the pressure of fuel within the control chamber 70, the shut off valve member 102 is urged into engagement with the shut off valve seating 118 such that communication between the upstream fuel supply passage 8a and the injector delivery chamber 52 (not shown in FIGS. 3A to 3E) is broken. Fuel within the downstream fuel supply passage 8b is permitted to flow to the drain passage 129 though the flow passages 126, 128 provided in the shut off valve member 102.

If it is desired to initiate fuel injection, the control valve 44 is actuated into its open position in order to evacuate the pressurised fuel within the control chamber 70 to low pressure. At this point, the force due to pressurised fuel within the upstream fuel supply passage 8a acting on the second surface 124 of the annular recess 120 is greater than the opposing force acting on the control piston 104 due to the now-reduced fuel pressure within the control chamber 70 so the shut off valve member 102 is urged away from its seating 118. This is the position shown in FIG. 3B.

As the shut off valve member 102 lifts away from the shut off valve seating 118 (shown in FIG. 3C), fuel is permitted to flow from the upstream fuel supply passage 8a, past the shut off valve seating 118 and into the downstream fuel supply passage 8b towards the injector delivery chamber 52. Fuel also flows through the flow passages 126, 128 and into the balance chamber 127. Fuel pressure thus builds rapidly within the downstream fuel supply passage 8b and the injector delivery chamber 52 which initiates a fuel injection event when nozzle opening pressure is reached. It should be appreciated the term “nozzle opening pressure” refers to the pressure of fuel present in the injector that is necessary for the force acting on the thrust surfaces 50 of the valve needle 46 to overcome the closing force of the spring 58. As the shut off valve member 102 reaches its full lift position (as shown in FIG. 3D), the frustoconical region 102b engages the second shut off valve seating 132 to prevent pressurised fuel from flowing from the balance chamber 127 to the low pressure drain 129.

In order to terminate fuel injection, the control valve 44 is actuated to its closed position which re-establishes high fuel pressure within the control chamber 70, as shown in FIG. 3E. The net force acting on the control piston 104 urges the shut off valve member 102 downwardly within the bore 106 which serves to disengage the shut off valve member 102 from the second shut off valve seating 132. Fuel is therefore permitted to flow from the balance chamber 127 to the low pressure drain 129 past the flat 130, and this serves to reduce the pressure of fuel within the downstream fuel supply passage 8b and the injection delivery chamber 52. The control piston 104 causes the shut off valve member 102 to re-engage the first shut off valve seating 118 quickly so as to resume the position shown in FIG. 3A, at which point fuel pressure within the downstream fuel supply passage 8b and the injector delivery chamber 52 decays rapidly, due partly to the natural pressure decay of the continued flow of fuel from the injector outlets 56 and also to the flow of fuel from the balance chamber 127 to the low pressure drain 129 past the second shut off valve seating 132. Fuel injection will cease when fuel pressure within the injector delivery chamber 52, and thus to the nozzle outlets 56, reduces to below nozzle closing pressure.

The balance chamber 127 is a particularly beneficial feature of the shut off valve arrangement in that it ensures the shut off valve member 102 lifts from the first shut off valve seating 118 and moves to engage the second shut off valve seating 132 at a controlled rate. This is because the force due to pressurised fuel acting on the frustoconical region 102b substantially balances the force due to the pressurised fuel acting on the lower end face 114. In the absence of the balance chamber 127, after the shut off valve member 102 lifts away from the seating 118 by a small amount, the entire lower end face 114 of the shut off valve member 102 is exposed to high pressure fuel. The high unbalanced force exerted on the shut off valve member 102 would then cause it to slam open against the second seating 132 in an uncontrolled manner, as is the case in FIG. 1. This is particularly undesirable in applications where it is required to move the injection valve needle 46 into and out of engagement with its seating 54 many times during an injection event, for example to achieve a pilot, main, and one or more post injections. Controlling the speed of movement of the shut off valve member 102 also serves to limit pressure wave activity within fuel flow passages to acceptable levels. In addition, it is possible for the uncontrolled movement, over time, to damage the shut off valve member 102.

It should be appreciated that the balance chamber 127 could also be supplied with fuel by a separate flow passage 140 (shown in dotted lines on FIG. 2) within the valve housing 108 to provide a communication path from the downstream fuel supply passage 8b to the balance chamber 127. The separate flow passage 140 may be provided instead of the axial and branch passages 126, 128 or in combination therewith.

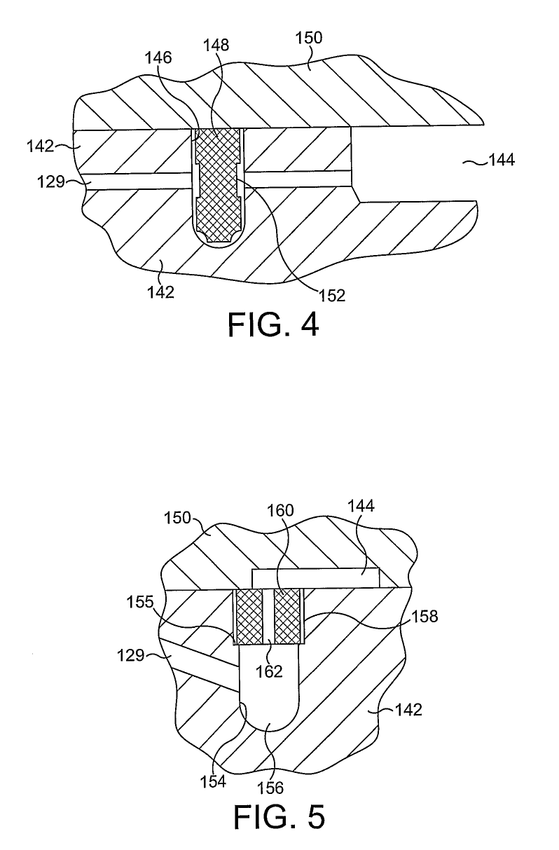

As has been mentioned above, the flat 130 provided on the shut off valve member 102 enables fuel to flow from the balance chamber 127 to the drain passage 129 and so provides an additional path through which fuel may spill out of the fuel supply passage 8. An alternative embodiment of the invention is shown in FIGS. 4 and 5 which show a means of restricting the flow of fuel through the drain passage 129. This provides a means to control the rate at which fuel pressure within the injector (downstream fuel supply passage 8b and injector delivery chamber 52) reduces, hereafter referred to as nozzle spill rate.

In FIG. 4, the drain passage 129 is shown as a lateral drilling through a section of valve housing 142, one end of the drain passage 129 communicating with the balance chamber 127 (not shown in FIG. 4) and the other end of the drilling 129 communicating with a low pressure volume 144. At an intermediate location between its ends, the drain passage 129 is provided with a longitudinal blind bore 146 defining a chamber of substantially cylindrical form which receives a substantially cylindrical restriction member 148 in the form of a barrel. The open end of the bore 146 is sealed by an adjacent housing piece 150 to prevent leakage of pressurised fuel.

The diameter of the barrel 148 is substantially the same as that of the bore 146 except for a middle region that is provided with a shallow annular recess 152. By virtue of the limited clearance the annular recess 152 defines with the bore 146, a restricted channel is provided through which fuel can flow from the balance chamber 127 to the low pressure volume 144. Conveniently, the rate of flow through the restricted channel may be selected by replacing the barrel 148 with another having either a deeper, or shallower, recess as required for a particular application. It should be appreciated that the barrel 148 defines a sealing fit within the bore 146 such that it may be inserted and removed freely whilst guarding against leakage of fuel from the drilling 129.

FIG. 5 shows an alternative means to restrict the flow of fuel from the balance chamber 127. Where appropriate, like parts are denoted with like reference numerals. In a manner similar to the embodiment shown previously, the drain passage 129 is provided in a valve housing 142 and opens into a longitudinal blind bore 154, the open end of which is closed by an adjacent housing piece 150. A step 155 divides the bore 154 into a lower chamber 156 having a slightly smaller diameter than that of an upper chamber 158 which receives a restriction member 160 in the form of a plate. The restriction plate 160 is received into the upper chamber 158 to abut the step 155 and is thus held in place within the upper chamber 158. The restriction plate 160 has a diameter substantially the same as that of the upper part of the bore 154 to minimise leakage of fuel past its outer surface but is provided with a restricted drilling 162 which restricts the flow of fuel passing therethrough from the lower chamber 156 into the low pressure volume 144. In practice, the restricted drilling 162 need not extend through the full depth of the restriction plate 160, from one side to the other, but instead the restriction plate 160 may be provided with a counter bore (unrestricted) so as to minimise the length of the restricted diameter drilling.

The restriction members of FIGS. 4 and 5 enable the restriction to fuel flowing out of the balance chamber 127 to low pressure to be selected specifically in accordance with a particular application and may be readily replaced to alter the drain rate out of the balance chamber 127. This provides a significant advantage in that complex re-drilling of housing parts to change the restriction rate is avoided.

In the above embodiments, restricting the rate of fuel flow out of the balance chamber 127 to the low pressure drain 129 occurs when the shut off valve member 102 is seated against the first shut off valve seating 118 and through a range of valve lift until the frustoconical region 102b of the shut off valve member 102 engages the second shut-off valve seating 132. In certain applications, however, it may be desirable to limit the drain of fuel to low pressure for only a portion of shut off valve lift. It has been recognised that the timing and duration of nozzle spill may be controlled by selecting when the drain passage 129 is permitted to communicate with the balance chamber 127 in circumstances in which the shut off valve member 102 is seated against, and when it is lifting away from, the first shut off valve seating 118.

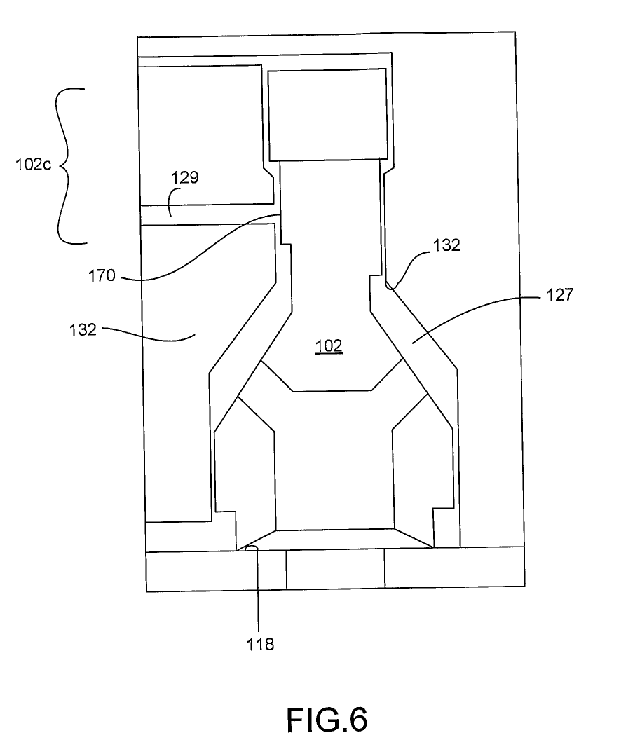

FIG. 6 shows a shut off valve arrangement which enables this to be achieved. The shut off valve arrangement in FIG. 6 is almost identical to the shut off valve arrangement in FIG. 2, therefore only the differences will be described here.

In FIG. 6, the neck region 102c of the shut off valve member 102 is provided with an enlarged region 170 which serves to occlude the drain passage 129 when the shut off valve member 102 is engaged with the first shut off valve seating 118 and also during at least a portion of valve movement away from the seating 118. Therefore, the drain passage 129 is only effective over a part of the range of movement of the shut off valve member 102, rather than being in communication with the balance chamber 127 at all times other than when the shut off valve member 102 is engaged with the second shut off valve seating 132 (i.e. as in FIG. 2).

The above arrangement provides a particular advantage in circumstances where it is desired to provide multiple successive injections of fuel into the combustion chamber. For example, it may be necessary to perform a relatively short pilot injection, a main injection and then one or more post injections, with the aim of improving exhaust emissions. By virtue of the above embodiment, pressure collapse within the nozzle may be limited by controlling the shut off valve member 102 in such a manner as to “hover” or “flutter” between its open and closed position by repeated actuation of the shut off control valve 44. Parasitic losses are therefore minimised.

It should be appreciated that the manner in which the shut off valve member 102 engages its first and second seatings 118, 132 are exemplary only and alternative seating arrangements could be used. For example, as an alternative to the outer edge of the lower end face 114 of the shut off valve member 102 defining a seating line 116 for engagement with the first shut off valve seating 118, the lower end face 114 could also be arranged as a face seal. Furthermore, although the opening of the intermediate region 106b of the bore 106 seals against the frustoconical region 102b of the shut off valve member 102, the shut off valve member 102 could be provided with a seating line formation to seal against the bore 106.

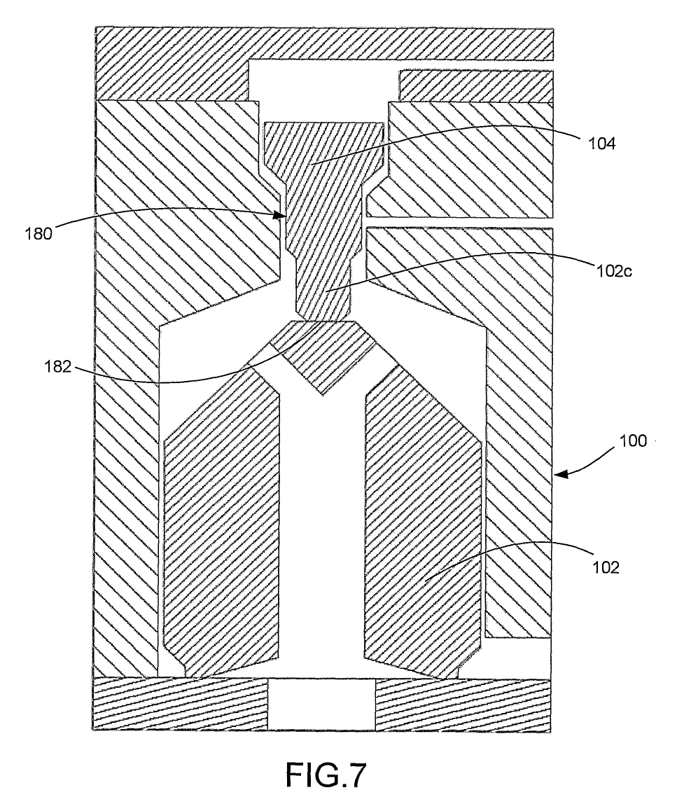

A further alternative shut off valve arrangement 100 is shown in FIG. 7 where it can be seen that the control piston 104 is of greater length than the control piston 104 in FIGS. 2 and 6 such that the control piston 104 and the neck region 102c are constituted by a single control member 180. A lower end face 182 of the control member 180 abuts an upper end face 184 of the shut off valve member 102.

In the above embodiments, since the diameter of the control piston 104 is greater than the diameter of the neck region 102c of the shut off valve member 102, it is necessary for the control piston 104 and the shut off valve member 102 to be separate parts so that they may be installed within a bore 106 defined by a single housing part. It is also possible to manufacture the shut off valve member 102 and the control piston 104 as a unitary part for installation within a two-piece bore 106 defined by respective adjacent housings. However, this is not preferred due to the difficulties in achieving sufficient alignment and concentricity between the two bores.

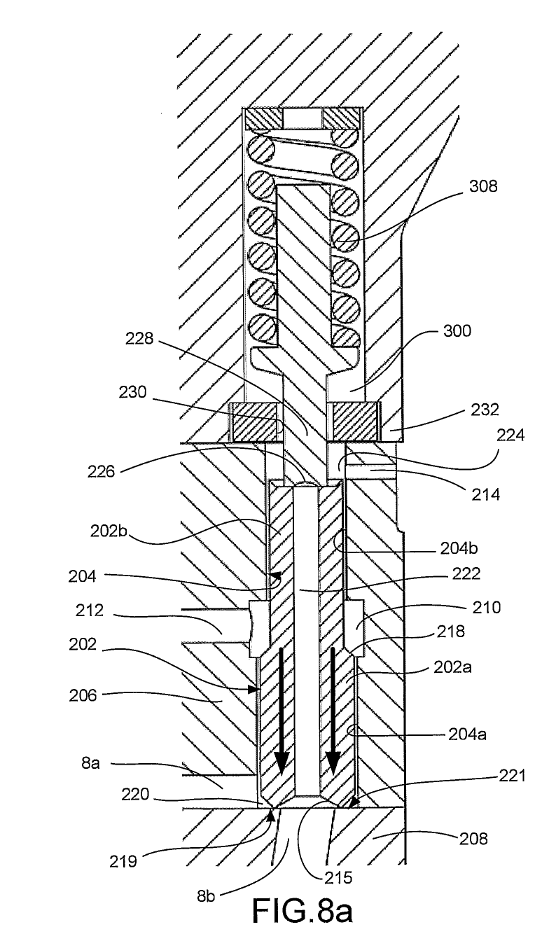

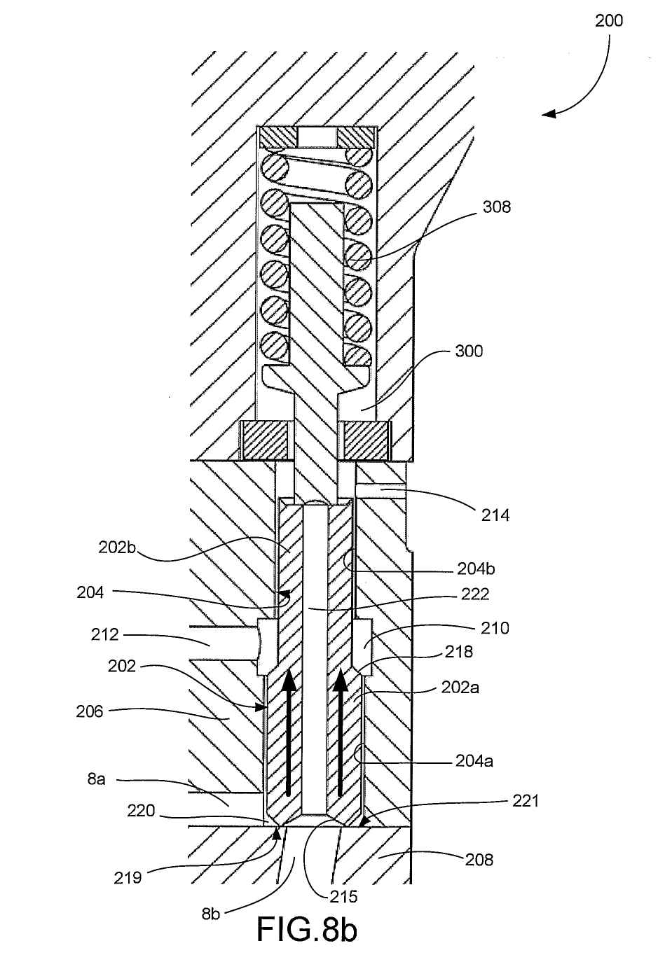

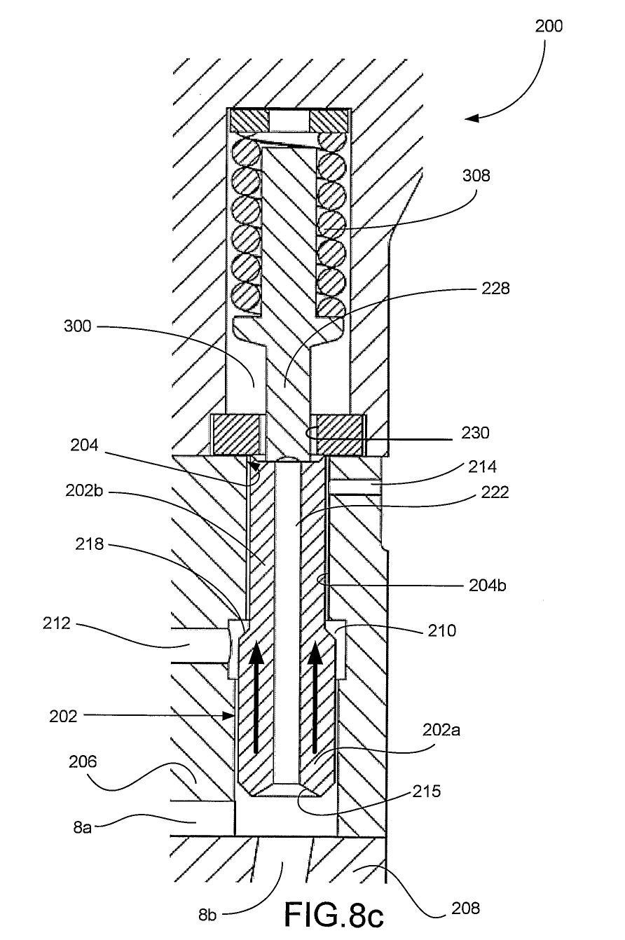

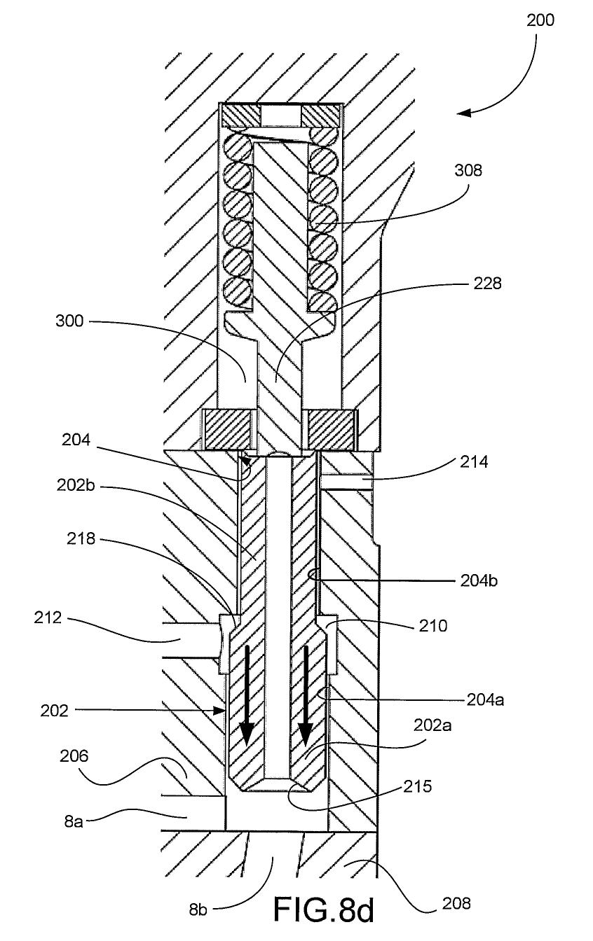

FIGS. 8A to 8D show an alternative shut off valve arrangement 200, in successive stages of operation, that addresses the concern mentioned above. Like the embodiments of FIGS. 2 and 6, the shut off valve arrangement 200 may also be incorporated into the fuel injection system in FIG. 1 and it is in this context in which it will now be described. Where appropriate, like features to those described previously are denoted with like reference numerals.

With reference to FIGS. 8A to 8D, a unitary shut off valve member 202 is slidable within a through bore 204 provided within a valve housing 206. A lower opening of the bore 204 opens into a downstream fuel supply passage 8b provided in an adjacent housing part 208, which conveys fuel to the injector delivery chamber 52 (not shown in FIGS. 8A to 8D) as described previously. Towards its upper end, the bore 204 communicates with a drain volume (not shown) by way of a drain passage 214 also provided within the valve housing 206.

Approximately midway along its length, the bore 204 is shaped to define an annular control chamber 210 of relatively large diameter which communicates with the control chamber 70 (not shown in FIGS. 8A to 8D) via a control passage 212. The pressure of fuel within the control chamber 210 determines the axial position of the shut off valve member 202 as will now be described.

A lower region 202a of the shut off valve member 202 is received by, and has a diameter substantially the same as, a lower region 204a of the bore 204 and has a diameter slightly larger than that of an upper region 202b of the shut off valve member 202, which is itself received within an upper region 204b of the bore 204. A transitional region midway along the length of the shut off valve member 202 is shaped to include thrust surfaces 218 which are exposed to fuel pressure within the control chamber 210, the thrust surfaces 218 serving to serving to impart a downward force to the shut off valve member 202 when the control chamber 210 is at high pressure.

In a similar manner to the shut off valve member 102 in FIG. 2, the lower end of the shut off valve member 202 defines an annular seating line 219 that is engageable with a substantially flat, first shut off valve seating 221, defined by the housing piece 208. Engagement between the shut off valve member 202 and the first shut off valve seating 221 serves to prevent fuel flowing from the upstream fuel supply passage 8a to the downstream fuel supply passage 8b. The shut off valve member 202 is also provided with an annular recess 220 which defines a volume in communication with the upstream fuel supply passage 8a, the annular recess 220 providing a surface exposed to high pressure fuel within the upstream fuel supply passage 8a so as to exert an upwards force on the shut off valve member 202. The lower end of the shut off valve member 202 also defines a lower end face 215 exposed to fuel pressure within the downstream fuel supply passage 8b.

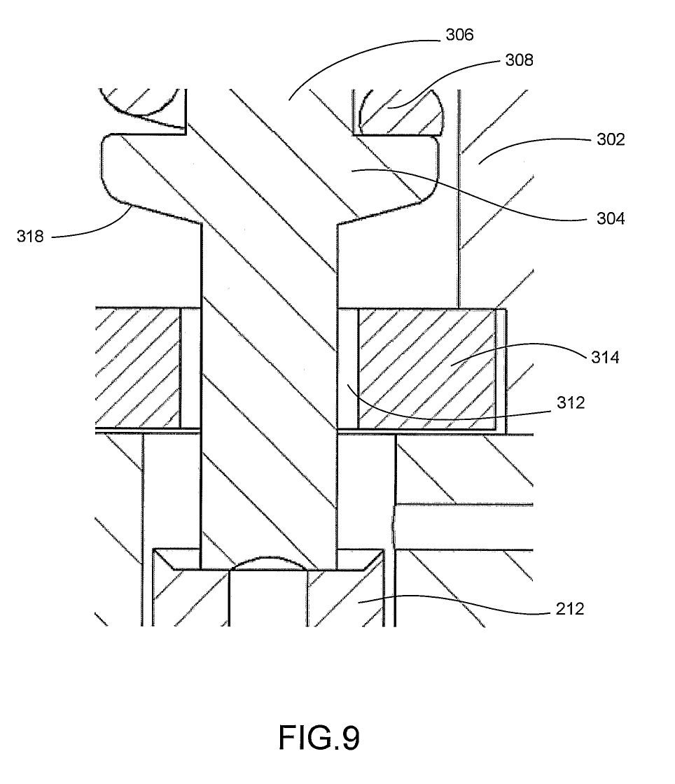

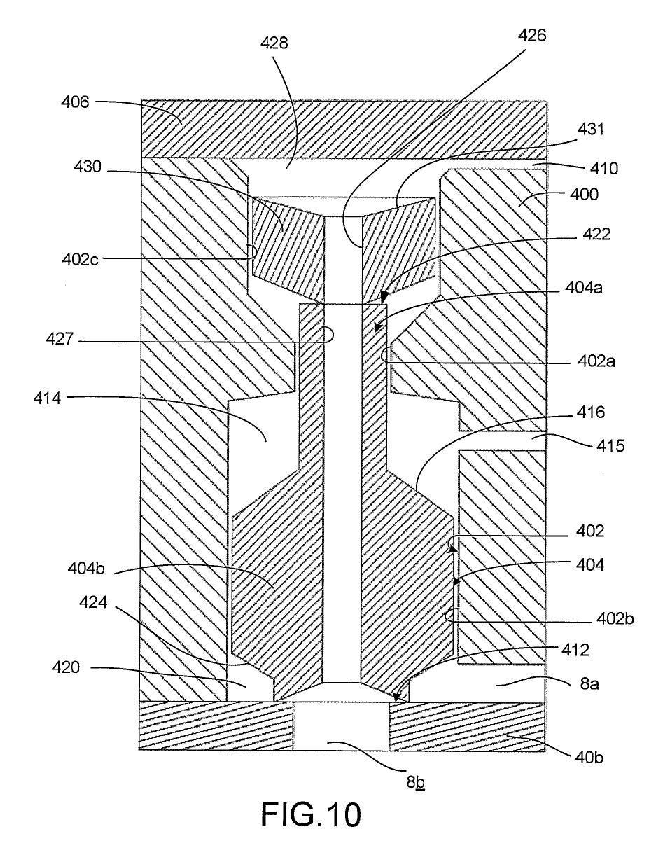

The shut off valve member 202 includes a longitudinally extending through bore 222 which provides a path through which fuel can flow from the downstream fuel supply passage 8b to a balance chamber 224 defined at the upper end of the bore 204 when the shut off valve member 202 is seated, as is shown in FIG. 8A. The balance chamber 224 is in communication with the drain passage 214 when the shut off valve member 202 is in this seated position. Fuel enters the balance chamber 224 from the bore 222 via a recess 226 provided in a lower end of a spring peg 228. The spring peg 228 abuts the upper face of the shut off valve member 202 and extends longitudinally away therefrom through a further bore 230 provided in a further housing 232. The spring peg 228 protrudes into a spring chamber 300 and carries a spring 308 that serves to provide a closing force to urge the shut off valve member 202 against its seat 221. It should be appreciated that fuel is permitted to flow from the balance chamber 224 into the spring chamber which guards against the spring peg 228 being separated from the shut off valve member 202. The spring peg 228 will be described in further detail later with reference to FIGS. 9 and 10.

Initially, the shut off valve member 202 is in the position shown in FIG. 8A and fuel injection does not take place. Upon actuation of the control valve 44, the fuel pressure within the control chamber 210 decreases rapidly such that the force due to pressurised fuel acting on the annular recess 220 drives the shut off valve member 202 to disengage the first shut off valve seating 221, as is shown in FIG. 8B. As the shut off valve member 202 lifts away from the seating 221, pressurised fuel is permitted to flow from the upstream fuel supply passage 8a to the downstream fuel supply passage 8b. Pressurised fuel therefore acts on the lower end face 215 of the shut off valve member 202 and, as a result, the shut off valve member 202 lifts from the seat 221 in a controlled way since the forces acting on the shut off valve member 202 are substantially balanced.

For a part of shut off valve lift, fuel within the chamber 224 is permitted to flow to low pressure via the drain passage 214. However, as the shut off valve member 202 approaches the full extent of its lift, its upper end will occlude the opening of the drain passage 214 such that fuel pressure builds rapidly within the injector nozzle. A fuel injection event will therefore occur. This is the position shown in FIG. 8C.

In order to terminate fuel injection, the control valve 44 is actuated to its closed position so as to re-establish high pressure within the chamber 210. The pressure of fuel acting on the downwardly directed thrust surface 218, together with the force transmitted by the spring peg 228, is sufficient to overcome the opposing force due to fuel pressure acting on the lower end face of the shut off valve member 202. The shut off valve member 202 is thus urged in a direction to re-engage the seating 221, as shown in FIG. 8D. During movement of the shut off valve member 202 towards the seating 221, the drain passage 214 is exposed to fuel within the chamber 224 such that the pressure within the downstream fuel supply passage 8b begins to reduce. However, fuel pressure in the downstream fuel supply passage 8b drops more rapidly when the shut off valve member 202 engages the seating 221 such that communication between the upstream and downstream fuel supply passages 8a, 8b is broken. Injection will be terminated when the pressure within the nozzle reduces to nozzle closing pressure.

FIG. 9 shows an enlarged view of the spring peg 228 of FIGS. 8A to 8D. Here it can be seen that the peg 228 is located within a spring chamber 300 provided in a chamber housing 302. The spring peg 228 comprises a generally longitudinal member having a flange 303 towards its lower end which divides the spring peg 228 into a relatively short end stub 304 that engages the upper end of the shut off valve member 202 and an upwardly projecting stem 306 over which a helical spring 308 is fitted. The end stub 304 is received within the bore 312 of an annular insert 314 which abuts the valve housing 206. An upper end of the spring 308 abuts a spring abutment member 310 positioned at the ceiling of the chamber 300 and a lower end of the spring 308 abuts the flange 303, the spring peg 228 therefore providing a seating force to the shut off valve member 202. Pressurised fuel is permitted to flow into the spring chamber 300 via a clearance 312 between the surface of the end stub 304 and the bore 312 of the annular insert 314.

The flange 303 serves to damp opening and closing movement of the shut off valve member 202 since pressurised fuel within the spring chamber 300 is forced to flow between the edge 316 of the flange 303 and the wall of the spring chamber 300. This provides a resistive force that is proportional to the speed of movement of the spring peg 228. The rate of damping is controlled by providing the flange 303 with flats to vary the restriction to the flow of fuel. Further, the flats can be provided with radiussed edges 318 such that, under identical loads, the spring peg 228 will be permitted to move in one direction faster than in the opposite direction, thus providing a further degree of control over the movement characteristics of the shut off valve member 202.

A further alternative shut off valve arrangement which may be incorporated into the fuel injection system of FIG. 1 is shown in FIG. 10 and it is in this context in which the embodiment will be described. Due to the similarities with the embodiments described above, where appropriate, like parts will be denoted with like reference numerals.

FIG. 10 shows a valve housing 400 provided with a longitudinal bore, referred to generally as 402, which is arranged to receive a shut off valve member 404. Each end of the bore 402 is closed by respective adjacent housing 406, 408.

At its upper end, the bore 402 is in communication with a low pressure volume (not shown) via a low pressure drain passage 410 provided in the valve housing 400. At its lower end, the bore 402 communicates with the upstream fuel supply passage 8a, also provided within the valve housing 400. The lower end of the bore 402 aligns with the downstream fuel supply passage 8b provided by the adjacent housing 408. Communication between the upstream and downstream fuel supply passages 8a, 8b is controlled by the position of the shut off valve member 404 relative to a first shut off valve seating 412 defined by the adjacent housing piece 408.

The bore 402 is shaped so as to include a mid region 402a having a smaller diameter than that of a lower region 402b and an annular gallery 414 between the two regions 402a, 402b that constitutes a control chamber. The pressure of fuel within the control chamber 414 is determined by the position of the control valve 44.

The shut off valve member 404 includes an upper region 404a and a lower region 404b, with the upper region 404a having a smaller diameter than that of the lower region 404b. Each of the regions 404a, 404b is slidable within a corresponding region 402a, 402b, respectively, of the bore 402. Between the upper and lower regions 404a, 404b, the shut off valve member 404 defines a thrust surface 416 that is exposed to fuel within the control chamber 414 so as to apply a downward force to the shut off valve member 404 urging it into engagement with the shut off valve seating 412.

As in previous embodiments, the lowermost end of the shut off valve member 404 is provided with an annular recess 420 to define a volume in communication with the upstream fuel supply passage 8a. The provision of the annular recess 420 provides the shut off valve member 404 with a lift surface 424 having an effective surface area which experiences a hydraulic lift force due to fuel pressure within the recess 420. The configuration of the lower region of the shut off valve member 404 is substantially identical to previous embodiments and will not be described in further detail here.

The upper end face 422 of the shut off valve member 404 abuts a balance plate member 430 which is received within, and has a diameter substantially the same as, a third, uppermost region 402c of the bore 402. The diameter of the uppermost region 402c has a larger diameter than the intermediate region 402a but a smaller diameter than the diameter of the lower region 402b. A drilling 426 provided in the balance plate member 430 is arranged to be substantially coaxial with a through bore 427 provided in the shut off valve member 404 so as to provide a flow path for fuel from the downstream fuel supply passage 8b to a balance chamber 428 at the upper end of the bore 402. A frustoconical upper end face 431 of the balance plate member 430 is exposed to fuel pressure within the balance chamber 428 so as to provide a closing force to the shut off valve member 404. This should be compared to the embodiment of FIGS. 8A to 8B in which, instead, a spring 308 serves to provide a balancing force to the shut off valve member 404.

As the control valve 44 (as in FIG. 1) is actuated to relieve the pressure of fuel within the annular chamber 414, by permitting passage of fuel through the control passage 415, the force due to high pressure fuel within the annular recess 420 which acts on the lift surface 424 is sufficient to urge the shut off valve member 404 out of engagement with the shut off valve seating 412. High pressure fuel within the upstream fuel supply passage 8a is therefore permitted to flow into the downstream fuel supply passage 8b to the injector. Pressurised fuel will also flow through the valve bore 427 into the balance chamber 428. Since the effective area of the upper face 431 of the balance plate member 430 is comparable with the effective surface area of the lift surface 424 at the lower end of the shut off valve member 404, opening movement of the shut off valve member 404 is controlled.

In this embodiment, the omission of a spring allows the volume of the balance chamber 428 to be made smaller, or minimised, thereby ensuring that a balancing force is established as rapidly as possible, and with as little fuel flow as possible, thus improving the dynamic balance of the shut off valve member 404.

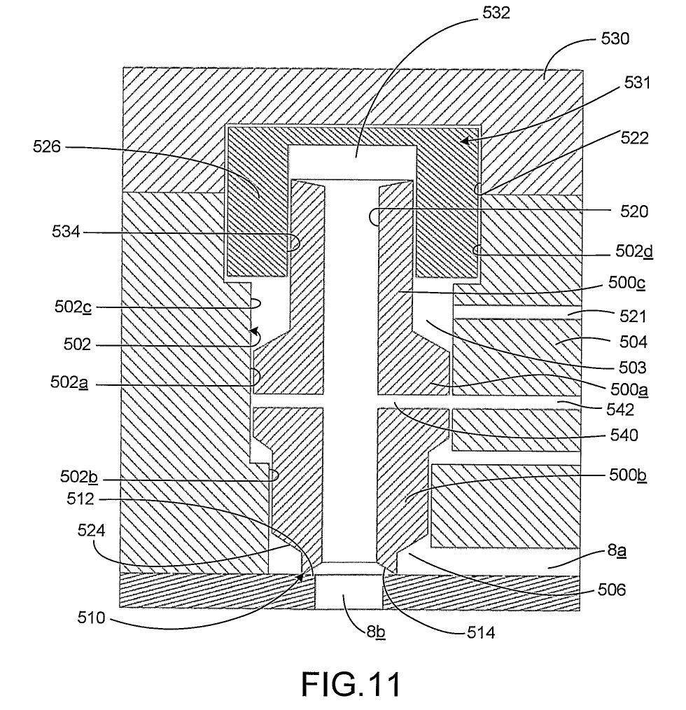

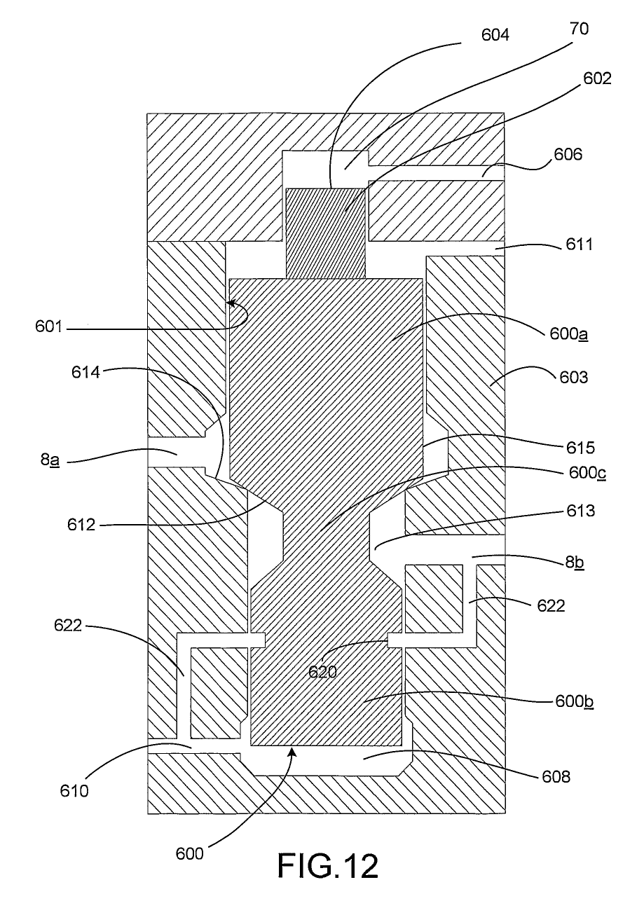

FIG. 11 shows a further alternative embodiment of the shut off valve arrangement, the construction and principle of operation of which are similar to the embodiments described previously such that only the differences will be described here.

The shut off valve member 500 includes an intermediate region 500a having a first diameter that is larger than a second diameter of a lower region 500b. Both the intermediate and lower regions 500a, 500b of the shut off valve member 500 are guided by respective intermediate and lower regions, 502a and 502b respectively, of a valve bore, referred to generally as 502, provided in a lower valve housing part 504. The intermediate region 500a of the shut off valve member 500 tapers into a narrower, upper region 500c having a diameter less than the diameters of the both the intermediate and lower regions 500a, 500b. The upper region 500c of the shut off valve member 500 also has a diameter which is less than that of an upper region 502c of the valve bore 502 such that the upper region 500c is not guided by the bore 502 in this upper region 502c.

As in previous embodiments, the lower end of the shut off valve member 500 is provided with an annular recess 506 to define a volume in communication with the upstream fuel supply passage 8a. The provision of the annular recess 506 defines a lift surface 524 of the shut off valve member 500 which has an effective surface area experiencing a hydraulic lift force due to fuel within the annular recess 506. The lower end of the shut off valve member 500 further defines an annular seating line 510 for engagement with a shut off valve seating 512 to control communication between the upstream and downstream fuel supply passages 8a, 8b. A lower end surface 514 of the shut off valve member 500 is exposed to fuel pressure within the downstream fuel supply passage 8b.

The transition between the intermediate region 500a and the upper region 500c of the shut off valve member 500 defines a first effective surface area that is exposed to high pressure fuel within a control chamber 503, defined between the upper region 502c of the bore and the upper region 500c of the shut off valve member 500. The pressure of fuel within the control chamber 503 is determined by the position of the control valve 44 via the control passage 521. In the position shown in FIG. 11, high pressure fuel acting on the first effective surface area of the upper region 500c imparts a closing force to the shut off valve member 500 that is greater than the force acting in the opposite direction on a second effective surface area defined by the annular recess 506.

The relatively small diameter of the upper region 500c of the shut off valve member 500 is provided to allow the shut off valve member 500 to be manufactured as a single part and received within (i.e. inserted into) the bore 502 in the lower housing part 504. An upper housing part 530 is arranged adjacent to the lower housing part 504 and is provided with a relatively wide recess or opening 531 which faces the upper region 502d of the bore 502 in the lower housing part 504. Together, the opening 531 and the upper end of the opening 502d receive a cap 522, of generally cup-like form, which defines an internal cap volume forming a balance chamber 532. An opening 534 of the cap 522 is defined by a downwardly depending cap annular wall 526.

The upper end 500c of the shut off valve member 500 is received within the cap 522 so as to extend into the internal cap volume 532. The cap opening 534 has a diameter substantially the same as the diameter of the upper region 500c of the shut off valve member 500 so as to prevent any fuel leakage between these two parts. The provision of the cap 522 is required to ensure the upper end of the shut off valve member 500 is guided, by virtue of co-operation between the cap 522 which it carries and the openings 531, 502d. A degree of lateral movement of the cap 522 is permitted within the opening 531 so that any misalignment of parts can be accommodated as the shut off valve member 500 moves axially, together with the cap 522.

As in previous embodiments, the shut off valve member 500 is provided with a longitudinal through bore 520 such that a flow path is provided for fuel to flow from the downstream fuel supply passage 8b to the balance chamber 532. Since the effective surface area of the upper end of the shut off valve member 500 which is exposed to fuel within the balance chamber 532 is substantially the same as the effective surface area of the lower surface 524 exposed to fuel pressure within the volume 506, the forces exerted on the shut off valve member 500 are substantially balanced as the shut off valve member 500 opens. In this way, lift of the shut off valve member 500 is well controlled.

The shut off valve member 500 is also provided with a lateral drilling 540 which, in the position shown in FIG. 11, aligns with a drain passage 542 provided in the lower housing part 504. Fuel within the downstream fuel supply passage 8b therefore has a path through which to vent to low pressure in a similar manner to previous embodiments. It should be appreciated that the positioning of the lateral drilling 540 may be selected so as to register with the drain passage 542 only during selected periods of movement of the shut off valve member 500 in order to provide a lift-dependent drain. The drain passage 542 may include a restriction member, as described previously with reference to FIGS. 4 and 5, in order to provide a further degree of control over the collapse of pressurised fuel within the injector fuel supply passage 8.

FIG. 12 shows another alternative construction of a shut off valve arrangement for use in the fuel injection system in FIG. 1. A shut off valve member 600 is slidable within a bore 601 provided in a valve housing 603 and includes an upper end region 600a, having a first diameter. The shut off valve member 600 includes a control piston 602 which defines a surface 604 exposed to fuel pressure within a control chamber 70. Pressurised fuel is conveyed to the control chamber 70 via a control passage 606. The lower end region 600b of the shut off valve member 600 has a second diameter and is exposed to fuel pressure within a drain chamber 608 defined at a blind end of the bore 601 which communicates with low pressure via a drain passage 610. The first diameter of the upper end region 600a of the shut off valve member 600 is greater than the second diameter of the lower end region 600b, the shut off valve member 600 being guided within the bore 601 at its first and second diameter regions, 600a, 600b respectively. A drain passage 611 is also provided in the valve housing 603 towards the upper end region 600a to ensure that fuel that leaks past the shut off valve member 600 may flow to low pressure instead of remaining in the volume of the bore 601 above the shut off valve member 600 which could result in a hydraulic lock.

An annular recess 613 provided on the shut off valve member 600 defines an intermediate region 600c between the upper and lower regions 600a, 600b. The intermediate region 600c defines a seating surface 612 of substantially frustoconical form that is engageable with a shut off valve seating 614 defined by the bore 601. The shut off valve seating 614 is also of frustoconical form. The seating surface 612 and the shut off valve seating 614 engage over an annular region in the form of a seating line having a diameter substantially equal to the second diameter, or guide diameter, of the lower region 600b of the shut off valve member 600. The annular chamber 615 is supplied with high pressure fuel by the upstream fuel supply passage 8a.

In this embodiment, a first effective surface area associated with the shut off valve member 600 is defined by the upper end face 604 of the control piston 602 and fuel pressure applied to the first effective surface area urges the shut off valve member 600 to close. A second effective surface area of the shut off valve member 600 is defined by the differential area of the seating surface 612, being the area of the exposed to high pressure fuel when the shut off valve member 600 is seated. The differential area is determined by the difference in diameters between the upper and lower regions 600a, 600b.

If the control valve 44 (as shown in FIG. 1) is operated to reduce the fuel pressure within the control chamber 70, the shut off valve member 600 will be moved out of engagement with the shut off valve seating 614 permitting high pressure fuel to flow from the upstream fuel supply passage 8a to the downstream fuel supply passage 8b, through and around the annular recess 613. The injector delivery chamber 52 of FIG. 1 is thus supplied with pressurised fuel. Conversely, if the control valve 44 is operated so as to pressurise the control chamber 70, the force acting on the control piston 602 is sufficient to re-engage the shut off valve member 600 with the shut off valve seating 614 against the opposing force due to fuel acting of the differential area of the seating surface 612. Communication between the upstream and downstream fuel supply passages 8a, 8b is therefore broken.

The lower end region 600b of the shut off valve member 600 is also provided with an annular groove 620 which, together with the bore 601, defines a volume that is communicable with a drain passage 622. One end of the drain passage 622 communicates with the downstream fuel supply passage 8b and the other end communicates with the drain chamber 608. The drain passage 622 therefore serves a purpose equivalent to that of the drain passage 129 in the embodiments of FIGS. 2 and 6 and improves the ability to control the collapse of fuel pressure within the injector fuel supply passage 8 towards the end of an injection event. As an optional modification, the drain passage 622 may be restricted as described above. Moreover, in order to provide a lift-dependent drain, the annular groove 620 may be positioned such that communication between the bore 601 and the drain passage 622 only occurs during a selected range of movement of the shut off valve member 600.

It will be appreciated that any of the aforementioned embodiments may benefit from the provision of a suitable flow restriction means, such as the restriction member 148 or 160 of FIGS. 4 and 5, which serves to restrict the flow of fuel between the balance chamber and a low pressure drain.

In the embodiment of FIG. 12 it will be appreciated that the first effective surface area of the shut off valve member 600, being the control area for the shut off valve member 600, is not defined by the same part of the shut off valve member 600 that defines the second effective surface area. This is because the shut off valve member 600 carries a separate part, in the form of the control piston 602, to define the first effective surface area. Whether the shut off valve member 600 is a unitary part, or whether it is formed of two or more parts, is therefore not an essential feature of the present invention, as will be appreciated from the accompanying claims.

1. A shut off valve arrangement for use in a fuel injection system including an injector, the shut off valve arrangement including:
a shut off valve member (102; 202; 404; 500; 600) operable between a closed position in which the shut off valve member (102; 202; 404; 500; 600) is engaged with a shut off valve seating (118; 221; 512; 614) and an open position in which the shut off valve member (102; 202; 404; 500; 600) is disengaged from the shut off valve seating (118; 221; 512; 614) to control the supply of fuel to the injector through a fuel supply passage (8),
wherein the shut off valve member (102; 202; 404; 500; 600) has, associated therewith, a first surface exposed to fuel pressure within a shut off valve control chamber (70; 210; 414; 503), a second surface exposed to fuel within the fuel supply passage (8) and a third surface exposed to fuel pressure in a balance chamber (127; 224; 428; 532),
a control valve (44) for controlling the pressure of fuel within the shut off control chamber (70; 210; 414; 503), thereby to control movement of the shut off valve member (102; 202; 404; 500; 600) between the open and closed positions, and
wherein the shut off valve arrangement is provided with communication means between the fuel supply passage (8) and the balance chamber (127; 224; 428; 532) so that a balancing force acting on the third surface due to fuel pressure in the balance chamber (127; 224; 428; 532) opposes an opening force acting on the second surface.

2. The shut off valve arrangement as claimed in claim 1, wherein the first surface of the shut off valve member (102; 202; 404; 500; 600) defines a first effective surface area exposed to fuel pressure within the shut off control chamber (70; 210; 414; 503) and wherein the second surface of the shut off valve member (102; 202; 404; 500; 600) is engageable with the shut off valve seating (118; 221; 512; 614) to control fuel flow through the fuel supply passage (8) and defines a second effective surface area exposed to fuel pressure within the fuel supply passage (8).

3. The shut off valve arrangement as claimed in claim 1 or claim 2, wherein the third surface of the shut off valve member (102; 202; 404; 500; 600) defines a third effective surface area which is exposed to fuel pressure within the balance chamber (127; 224; 428; 532).

4. The shut off valve arrangement as claimed in any one of claims 1 to 3, wherein the first surface is defined by a first end region of the shut off valve member (102; 202; 404; 500; 600), the second surface is defined by a second end region of the shut off valve member (102; 202; 404; 500; 600) and wherein the third surface is defined by an intermediate region of the shut off valve member (102; 202; 404; 500; 600).

5. The shut off valve arrangement as claimed in any one of claims 1 to 4, wherein the communication means includes a passage provided through the shut off valve member (102; 202; 404; 500; 600), one end of which opens into the fuel supply passage (8) and the other end of which opens into the balance chamber (127; 224; 428; 532).

6. The shut off valve arrangement as claimed in any one of claims 1 to 5, wherein the shut off valve arrangement further includes drain means (129; 214; 410; 540; 610) for allowing fuel within the balance chamber (127; 224; 428; 532) to flow to a low pressure drain.

7. The shut off valve arrangement as claimed in claim 6, wherein the drain means (129; 214; 410; 540; 610) is only effective over a part of the range of movement of the shut off valve member (102; 202; 404; 500; 600).

8. The shut off valve arrangement as claimed in claim 6 or claim 7, wherein the drain means (129; 214; 410; 540; 610) includes a flow restriction means (148; 160, 162) for restricting the rate of flow of fuel from the balance chamber (127; 224; 428; 532) to the low pressure drain.

9. The shut off valve arrangement as claimed in claim 8, wherein the flow restriction means includes a restriction member (148, 160) located within a drain passage (129) provided in a shut off valve housing (142).

10. The shut off valve arrangement as claimed in claim 9, wherein the restriction member (148) defines an annular restriction for fuel flow through the drain passage (129).

11. The shut off valve arrangement as claimed in claim 9, wherein the restriction member (160) is provided with a through drilling (162) to define the flow restriction means.

12. The shut off valve arrangement as claimed in any one of claims 1 to 11, wherein the control chamber (70) is defined at an end of the shut off valve member (102; 600).

13. The shut off valve arrangement as claimed in any one of claims 1 to 11, wherein the balance chamber (224; 428; 532) is defined at an end of the shut off valve member (202; 404; 500).

14. The shut off valve arrangement as claimed in claim 13, wherein the shut off valve arrangement further comprises a spring (308) which serves to urge the shut off valve member (202) towards the shut off valve seating (221).

15. The shut off valve arrangement as claimed in claim 13 or claim 14, wherein the shut off valve member (500) includes a first part slidable within a first bore (502) provided in a shut off valve housing (504) and a second part slidable within a second bore (534) provided in a separate, movable housing part (522), wherein the separate housing part (522) is received within the first bore (502) so that the first and second bores (502, 534) open into one another.

16. A shut off valve arrangement for use in a fuel injection system including an injector, the shut off valve arrangement including:
a shut off valve member (102; 202; 404; 500; 600) operable between a closed position in which the shut off valve member (102; 202; 404; 500; 600) is engaged with a shut off valve seating (118; 221; 512; 614) and an open position in which the shut off valve member (102; 202; 404; 500; 600) is disengaged from the shut off valve seating (118; 221; 512; 614) to control the supply of fuel to the injector through a fuel supply passage (8),
a control valve (44) for controlling the pressure of fuel within the shut off control chamber (70; 210; 414; 503), thereby to control movement of the shut off valve member (102; 202; 404; 500; 600) between the open and closed positions,
the shut off valve arrangement further including drain means (129; 214; 410; 540; 610, 620, 622) for allowing fuel within the fuel supply passage (8) to flow to a low pressure drain.

17. The shut off valve arrangement as claimed in claim 16, wherein the drain means (129; 214; 410; 540; 610, 620, 622) is only effective over a part of the range of movement of the shut off valve member (102; 202; 404; 500; 600).

18. The shut off valve arrangement as claimed in claim 17, wherein the drain means includes a drain passage (129; 622) and wherein the shut off valve member (102; 202; 404; 500; 600) is shaped so as to close the drain passage (129; 622) during a part of the range of movement of the shut off valve member (102; 202; 404; 500; 600).

19. The shut off valve arrangement as claimed in claim 18, wherein the drain passage (129; 622) includes a flow restriction means (148; 160, 162) for restricting the rate of flow of fuel from the fuel supply passage (8) to the low pressure drain.

20. The shut off valve arrangement as claimed in claim 19, wherein the flow restriction means includes a restriction member (148, 160) located within the drain passage (129; 622).

21. The shut off valve arrangement as claimed in claim 20, wherein the restriction member (148) defines an annular restriction for fuel flow through the drain passage (129; 622).

22. The shut off valve arrangement as claimed in claim 20, wherein the restriction member (160) is provided with a through drilling (162) to define the flow restriction means.

23. The shut off valve arrangement as claimed in any one of claims 16 to 22, wherein the shut off valve member (102; 202; 404; 500) includes a first surface that is exposed to fuel pressure within a shut off valve control chamber (70; 210; 414; 503), a second surface exposed to fuel within the fuel supply passage (8) and a third surface exposed to fuel pressure in a balance chamber (127; 224; 428; 532), and wherein fuel flows to the drain passage (129) from the fuel supply passage (8) via the balance chamber (127; 224; 428; 532).

24. A fuel injection system including high pressure fuel supply means (4) for supplying high pressure fuel to a fuel injector arrangement (6) via a fuel supply passage (8) and a shut off valve arrangement as claimed in any one of claims 1 to 23 for controlling the flow of fuel to the fuel injector arrangement (6) through the fuel supply passage (8).
